(19) United States
(12) Patent Application Publication
(10) Pub. No.: US 2013/0097869 A1
(43) Pub. Date: Apr. 25, 2013

(54) SHAVING AID GEOMETRY FOR WET SHAVE SYSTEM

(71) Applicant: The Gillette Company, Boston, MA (US)

(72) Inventors: Xiandong Wang, Acton, MA (US); Neville Sonnenberg, Newton, MA (US); Joseph DePuydt, Loveland, OH (US); Michael J. Kwiecien, Scituate, MA (US); William Jolley, Spencer, MA (US)

(73) Assignee: THE GILLETTE COMPANY, Boston, MA (US)

(21) Appl. No.: 13/655,318

(22) Filed: Oct. 18, 2012

Related U.S. Application Data
(63) Continuation of application No. 12/174,317, filed on Jul. 16, 2008.

(51) Int. Cl. B26B 21/44

(52) U.S. Cl. CPC B26B 21/443
USPC 30/41

(57) ABSTRACT

The invention discloses a novel geometry for a lubricating body, strip or cap, composed of shaving aids, taking into consideration their shape, materials and placement along with their interaction with multiple blades for improved shaving attributes in a wet shaving system. A strip exposure and a strip angle are disclosed where generally a maximum height of the lubricating body in a dry state is greater than or equal to the maximum height of the blade plane and thus, the skin contacting surface of the lubricating body is generally above the skin contacting surface of the blades.

### FIELD OF THE INVENTION

This invention relates to razor cartridges, and more particularly to a lubricating body, strip or cap composed of shaving aids for a razor cartridge.

### BACKGROUND OF THE INVENTION

A wet shave razor cartridge is typically composed of a number of sharp blades, a fin guard and at least one shaving aid composite. The shaving aid composite is also sometimes known in the art as a lubricating strip, which continuously releases a shaving aid, typically a lubricant, during the shaving process. Lubricating strips are described in U.S. Pat. No. 6,301,785, U.S. Pat. No. 4,170,821 and GB Patent No. 2,024,082. The shaving aid strip is generally composed of a water-insoluble polymer matrix, typically, polystyrene, and a water-soluble shaving aid, typically polyethylene oxide, which leaches out of the strip during shaving to enhance shave comfort. Increasing the release of lubricant further improves the wet shave experience. This increase has been realized by modifying the shaving aid strip chemistry or formulation. For instance, the use of a certain portion of low molecular weight polyethylene oxide (as described in U.S. Pat. No. 5,113,585), or incorporating a small amount of polycaprolactone (as described in U.S. Pat. No. 6,301,785), without adversely affecting the structural integrity of the strip. It also has been known that a lubricating strip plays a very significant role in reduction of cartridge drag and decrease of hair pulling/tugging, and ultimately provides many benefits such as a safe, comfortable, and smooth shave.

It is also known in the art that a good shave (e.g. comfort and less-irritation) may generally be achieved through either a sophisticated design of a cartridge and handle, or by employing more blades (e.g. 3, 4 and 5 blades) to increase shaving efficiency, or by a significant reduction of blades' hair cutting force via strengthening of the blade edge, optimizing the blade edge profile, or applying a thin lubricious polymer coating on the blade edge. Thus, blades have been made sharper and stronger and slimmer to achieve low cutting force of the blade on a user's skin. Such blades are described in U.S. Pat. Nos. 6,866,894 and 6,684,513, wherein the dimensions of a sharp, slim blade are described.

However, as blades have become sharper, some users have realized adverse affects in that their skin is very sensitive to extremely sharp blades due to their type of skin or their facial contour/curvature, and hence, discomfort, irritation or even nicks and cuts, have been increasingly realized with these sharper, slimmer, and stronger blades.

Thus there is a need to improve the current shaving experience being realized with these sharper, slimmer and stronger blades.

### SUMMARY OF THE INVENTION

The invention provides a razor cartridge including a plurality of blades and at least one lubricating body, where the body has a maximum height greater than or equal to a maximum blade plane height of said plurality of blades. The lubricating body can be a lubricating strip or a cap or a coated cap, and may be any shape. The blades may be any type and may be of mixed types. For instance, the blades may include low cutting force (sharp) blades. The blades may be at the same height or at different heights. The lubricating body maximum height may be greater than or equal to a height of a blade or blades most proximal to said lubricating body.

In another embodiment of the present invention, a razor cartridge includes a plurality of blades and at least one lubricating body having a strip exposure greater than or equal to about −0.10 millimeters, about 0.00 mm and about 0.10 mm or between about −0.10 mm and about 0.00 mm. The razor cartridge may include a strip angle greater than or equal to zero degrees or between about 0 degrees and about 10 degrees. The lubricating body is a strip or a cap and of any shape. The blades may be of any type, of mixed type and may be at the same heights or a different height. In one aspect, the lubricating body may be in contact with fluid. In certain embodiments, the strip exposure may be relative to a blade or blades, of the plurality of blades, most proximal to said lubricating body.

In yet another embodiment, the razor cartridge includes a plurality of blades at least one lubricating body having a strip exposure greater than or equal to −0.10 millimeters and a strip angle greater than or equal to zero degrees during shaving.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a prior art cross-sectional side view of a lubricating strip relative to the blades.

FIGS. 2 and 2a are side views of a mushroom shaped lubricating strip relative to the blades showing the lubricating strip exposure in accordance with the present invention.

FIG. 3 is a side view of a mushroom shaped lubricating strip relative to the blades showing the lubricating strip exposure in accordance with the present invention.

FIG. 3a is a table of cross-sectional views of different types of lubricating bodies.

FIG. 4 is a side view of a rectangular shaped cap or strip relative to the blades showing the strip exposure in accordance with the present invention.

FIG. 5 is a side view of a sloped cap or strip relative to the blades showing the strip exposure in accordance with the present invention.

FIG. 6 is a side view of a cylindrically shaped cap or strip relative to the blades showing the strip exposure in accordance with the present invention.

FIG. 7 is a side view of a mushroom shaped cap relative to the blades showing the strip exposure in accordance with the present invention.

FIG. 8 is a side view of a lubricating strip relative to the blades showing the lubricating strip angle in accordance with the present invention.

FIG. 9 is a side view showing a swelling of a lubricating strip relative to the blades in accordance with the present invention.

FIG. 10 is a side view of a lubricating strip relative to a mixed height blade plane in accordance with the present invention.

### DETAILED DESCRIPTION OF THE INVENTION

One significant area that has been not been developed in the prior art is the interaction between the multiple blades and the lubricating strip or cap, and the combined geometry optimization of low cutting force (sharper, slimmer, stronger) blades' edge profile relative to the lubricating strip or cap.

The invention discloses a novel geometry for a lubricating body such as a strip or cap (composed of shaving aids) taking into consideration their shape, materials and placement along with their interaction with multiple sharp blades for improved shaving attributes in a wet shaving system.

The term “geometry” in the present invention signifies both the placement of the strip or cap relative to the blade plane of the razor cartridge and the shape or form or materials of the strip or cap.

A shaving aid is a generic term signifying chemicals within a lubrastrip or those chemicals coated on or embedded in cap. These chemicals may benefit wet shaving users as they are released during shaving.

In the present invention, the lubricating body, strips, caps, or lubricious caps, that are composed of shaving aids are important components of the razor cartridge because generally they play many roles for wet shaving. Firstly, the strip or cap is capable of delivering lubricant onto a user's skin surface while shaving to reduce drag and achieve a smooth shave, while also possibly releasing other chemical ingredients to benefit the skin. Secondly, the strip or cap assists with skin management by slightly stretching the skin to achieve more efficient and closer shave. Thirdly, either functions as a wear-indicator if a color strip is incorporated on its top surface, which signals it soon might be time for a new cartridge. Lastly, the lubricating strip or cap acts as a shoulder to share some of the load from the total pressure exerted by a user on the cartridge.

The cap additionally provides safety for a user while shaving primarily so that the rearmost blades will not cut the user's skin.

Since the “geometry” of the body (e.g., strip or cap) is an important aspect in the present invention, the following terms will be important aspects to the present invention and will be described in more detail with regard to the figures below. These terms are: Strip Exposure, Strip Height or Strip Plane (or Maximum Strip Height), Strip Angle, and Blade Plane Height (or Maximum Blade Plane Height).

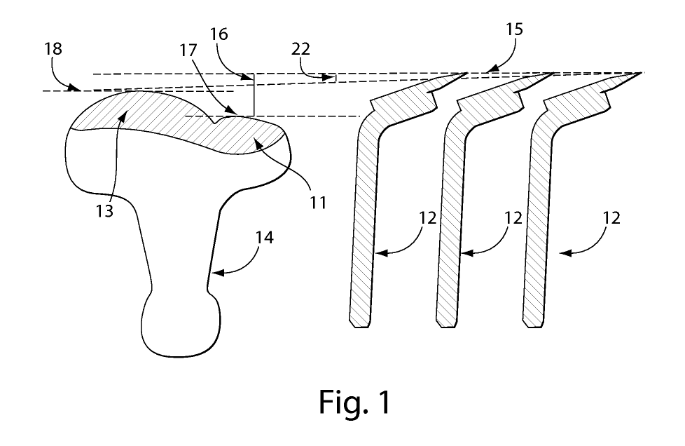

In the prior art, as shown in FIG. 1, a multiple blade razor system 10 is shown including razor blades 12 and a lubricating strip 14 where the blade plane 15 is at a height which is greater than the lubricating strip plane 18 or the maximum height (or uppermost surface) of the lubricating strip 14. Blade plane 15 is also at a height greater than the lubricating strip plane 17 (or highest point of lower lobe 11).

A strip exposure 16 is generally defined as the distance between a maximum height 18 of lubricating strip 14 and the blade plane 15 or the maximum height of the blades, though it can vary depending upon the type of strip 14 or the surface profile of the strip. In the case of a mushroom shape surface, however, such as the type shown in FIG. 1, which may have two concave surfaces or lower lobe 11 and upper lobe 13, the strip exposure 16 is typically defined as the distance between blade plane 15 and the parallel plane extending from the highest point 17 of the lower lobe 11 of strip 14. In the prior art, the strip exposure 16 of FIG. 1 typically ranges from about −0.50 mm to about −0.12 mm. It should be noted that the prior art strip exposures range in the negative numbers since the strip height is a smaller number than the blade plane height.

The optimized geometry with the most appropriate formulation and process (whether it be extrusion, molding or calendaring) will reduce the blade load to achieve the most comfortable shave but without sacrificing closeness. In the present invention, the interaction and synergistic effect between the blades and the geometry optimization of the lubricating strip will be described.

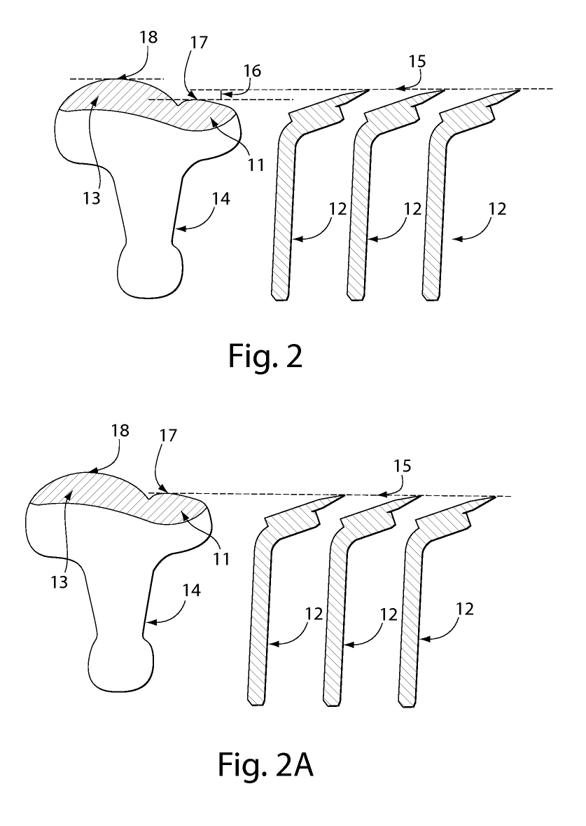

As depicted in FIG. 2, in accordance with one embodiment of the present invention, a multiple blade razor system 10 is shown including razor blades 12 and a lubricating strip 14 having a lubricating strip exposure or strip exposure 16 where the strip exposure is the distance between a maximum height of lubricating strip 14 and a maximum height of the blades or the blade plane 15, though it can vary depending upon the type of strip 14 or the surface profile of the strip and the type and heights of the blades. Generally, as shown, a maximum blade plane height is determined by the highest point of a line drawn between a first blade tip of the blade 12a, blade 12a which is most proximal to the lubricating body 14, and a second blade tip of the blade 12c, blade 12c being least proximal to the lubricating body 14.

Hence, the skin contacting surface of the lubricating strip 14 is generally above the skin contacting surface of the blades in accordance with the present invention. In the case of a mushroom shape surface such as the type shown in FIG. 2, which may have two concave surfaces or lobes 11 and 13, the lubricating strip exposure 16 is generally defined as the distance between blade plane 15 and the parallel plane extending from the highest point 17 of the lower lobe 11 of strip 14.

The strip exposure 16 in the embodiment shown in FIG. 2 ranges from about −0.10 mm to about 0.00 mm. It should be noted that the blade plane 15 is disposed at a height lower than the lubricating strip height point 18 and accordingly, the strip 14 is considered to be overall higher than the blade plane. If the blade plane 15 and the highest point 17 of the lower lobe are about on the same plane as shown in another embodiment of the present invention in FIG. 2a, the strip exposure 16 will be about 0.00 mm as there will substantially be no height differential.

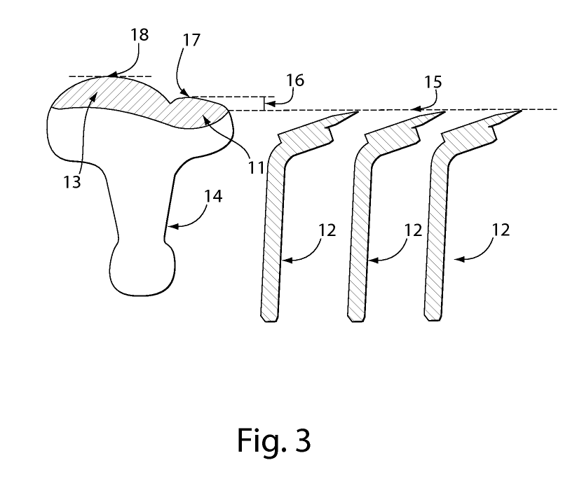

In FIG. 2, the blade plane 15 is shown disposed between lubricating strip height or highest point 18 of the upper lobe 13 and highest point 17 of the lower lobe 11 of strip 14. However, in another embodiment of the present invention, particularly with regard to the mushroom shape strip 14, the blade plane 15 may fall at or below lower lobe 11 and have a strip exposure as described below in conjunction with FIG. 3.

As depicted in FIG. 3, a multiple blade razor system 10 is shown including razor blades 12 and a mushroom shape lubricating strip 14 having a strip exposure 16 where the strip exposure is the distance between the maximum height of lubricating strip 14 and the blade plane 15 or the maximum height of the blades, where, again in this mushroom shape strip embodiment, the strip exposure 16 is defined as the distance between blade plane 15 and the parallel plane extending from the highest point 17 of the lower lobe 11 of strip 14. As shown in FIG. 3, the blade plane 15 is lower than strip height plane 17 and thus strip exposure 16 will be in the positive numerical range.

In the embodiment shown in FIG. 3, the lubricating strip (or cap) has a strip exposure 16 ranging from about 0.00 mm to about 0.10 mm and desirably may have a strip exposure from about 0.00 mm to about 0.05 mm.

Therefore, taking into consideration both embodiments of FIGS. 2, 2a and 3 of the present invention, the strip exposure 16 may range from about −0.10 to about 0.10 mm and desirably may have a strip exposure from about 0.00 mm to about 0.05 mm.

Thus, for the mushroom shape strip or cap, as long as the blade plane 15 is at or below maximum strip height 18, a strip exposure 16 is formed as provided by the present invention. Hence, a blade plane 15 falling anywhere in between height 18 and height 17 or below height 17 is generally considered to form a strip exposure 16 within the scope of the present invention. It should also be noted that the typical height differential of upper and lower lobes in a mushroom shaped strip or cap is about 200 μm to 250 μm.

In addition to the mushroom shapes shown in FIGS. 2-3, the shape or form of the strip or cap in the present invention may also be, though not limited to, rectangular, cylindrical, triangular or any combination thereof, as shown in FIG. 3a. The strip or cap may also be a thick film forming any shape noted below or alternatively, the strip may be a lubricious layer only on the top surface of the strip or cap.

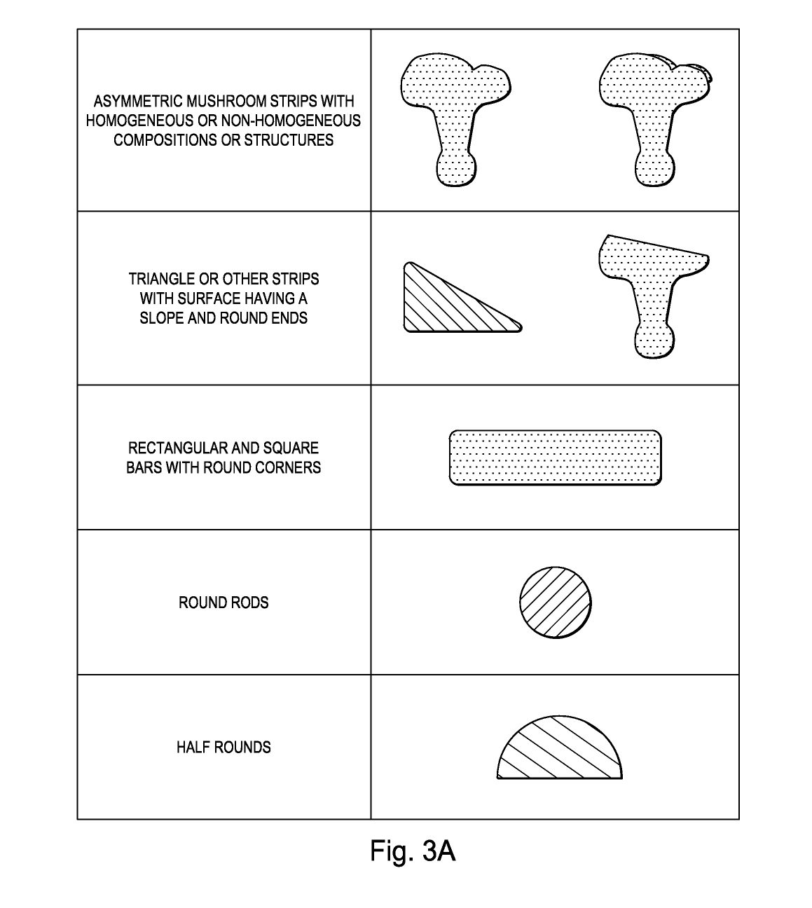

With a rectangular or flat strip or cap of the type as shown in FIG. 3a, the strip exposure 16 is the distance between the maximum height of the lubricating strip or strip plane 18 and the blade plane 15 as shown in FIG. 4 which depicts a lubricious material 14a coated on a non (or less) lubricious cap 14 in accordance with another embodiment of the present invention and which equivalently could be a similarly formed and placed lubricious strip 14. Since the strip plane 18 is higher than the blade plane 15, the strip exposure 16 will be a positive number ranging from about 0.00 mm to about 0.10 mm and may desirably range from about 0.00 mm to about 0.05 mm.

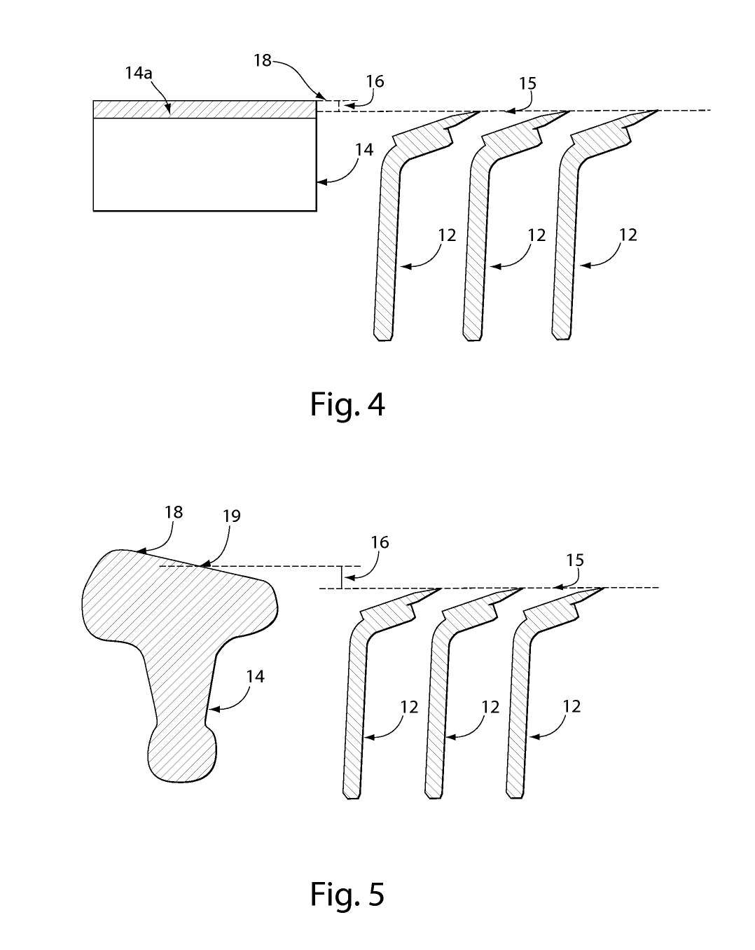

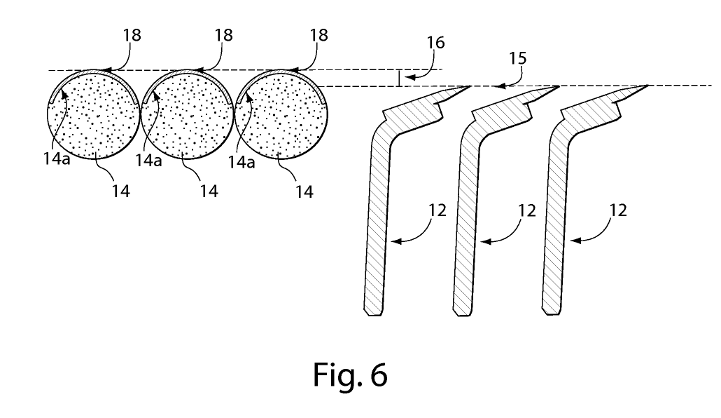

If the strip surface is flat but has a slope against blade plane as shown in FIG. 5, the strip exposure 16 is defined as the distance between blade plane 15 and its parallel plane on which the center longitude line 19 of the strip resides. If the strip is cylindrical or a round rod, strip exposure is defined as the distance between the blade plane and the parallel plane across the highest points of the strip as shown in FIG. 6 which depicts a lubricious material 14a coated on a non (or less) lubricious cap 14 in accordance with another embodiment of the present invention and which equivalently could be a similarly formed and placed lubricious strip 14. Since the strip plane 18 is higher than the blade plane 15, the strip exposure 16 will be a positive number ranging from about 0.00 mm to about 0.10 mm and may desirably range from about 0.00 mm to about 0.05 mm.

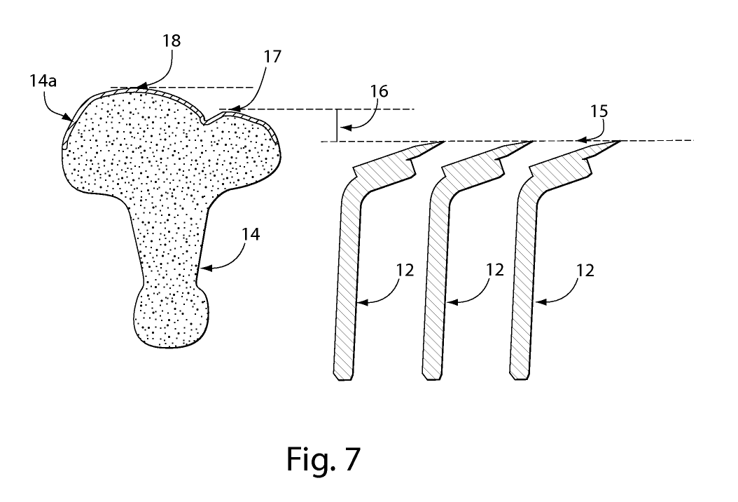

Additionally, in accordance with the present invention, FIG. 7 depicts a mushroom shaped cap 14 having a positive strip exposure 16 ranging from about 0.00 mm to about 0.10 mm and may desirably range from about 0.00 mm to about 0.05 mm as the blade plane 15 is depicted at a lower height than the maximum height 17 of the lower lobe 11. The cap 14 may be coated with a lubricious material 14a.

The present invention may also apply to a razor cartridge having both a cap and a strip or any number of caps or strips (not shown). In the case where both a cap and a strip are present, it may be that only the strip has a strip exposure in the range of about −0.10 mm to about +0.10 mm and desirably about 0.00 mm to about 0.05 mm of the present invention and the cap does not, or where the cap only has a strip exposure of the present invention and the strip does not, or where both have a strip exposure as provided by the present invention. The present invention may also apply to a razor cartridge having a strip but no cap, or having a cap but no strip, where in either of the latter instances, there is still a strip exposure as provided by the present invention.

As mentioned above, in the present invention, the lubricating strip (or cap) may have a strip exposure 16 ranging from about −0.10 mm to about 0.10 mm and desirably may have a strip exposure from about 0.00 mm to about 0.05 mm. It has been determined that lubricating strips with strip exposures that are slightly negative, zero or greater than zero (e.g., a positive value), or where the strip plane is just slightly below, at or higher than the blade plane, directly improve comfort-related shaving attributes such as comfort during and after shaving without loss of any other shaving attribute such as overall performance, freedom from nicks and closeness, and in some instances, there may be an indirect improvement, such as with shaving closeness. Therefore, even a very small height change in the strip exposure provides a noticed benefit to the user in terms of shaving attributes.

This results because despite being only a slight change in strip exposure, the new geometry may significantly reduce the blade force load, especially for those blades which are more proximal to the strip and additionally, may also affect load distribution. In a five blade razor cartridge, for instance, the most proximal blades affected may be the last 2 or 3 blades. In some instances, up to a 30% reduction in blade force load may be appreciated. This in turn leads to the improved shaving attributes. Accordingly, it is the geometry of the strip which may translate directly into improved shaving attributes such as comfort and closeness, etc.

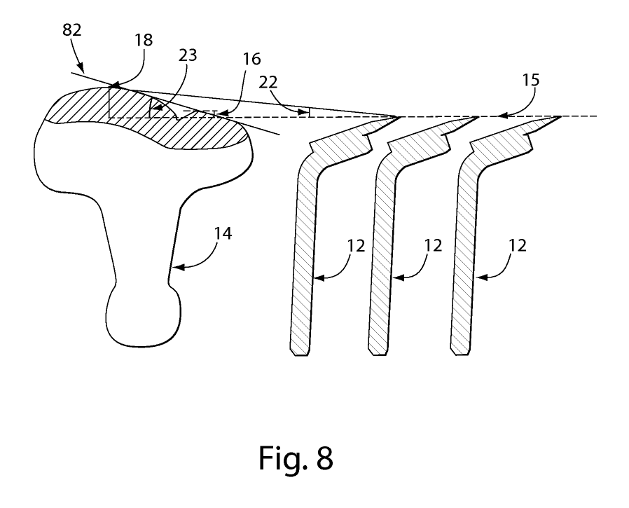

Referring now to FIG. 8, a multiple blade razor system 10 is shown including the relative strip angle 22, portrayed in accordance with the present invention as the angle 22 formed between the line drawn from the maximum height of the blade plane 15 towards the lubricating body and the uppermost surface or maximum height 18 of the upper lobe 13 of lubricating strip 14.

In the present invention, the lubricating strip 14 may have a relative strip angle that ranges from about 0 degrees to about 10 degrees, (or about 5.0±5.0 degrees), and desirably may have a strip angle that ranges from about 1 degree to about 7 degrees (or about 4.0±3.0 degrees). On the contrary, the prior art strip angle 22, as shown in FIG. 1, would essentially be a zero angle or a negative angle.

It should be noted that the strip angle differs from what is known as the tilt angle of the strip. The tilt angle is the angle at which the strip sits in the cartridge and is defined as the angle between the blade edge plane 15 and a strip surface plane 82. For instance, referring back to FIG. 8, the tilt angle 23 is bigger than the strip angle 22.

A typical shaving aid found in a lubricating strip or lubricious coated cap or cap for instance, may include polyethylene oxide (PEO) as the main lubricant, polystyrene (PS) as a matrix and other minor ingredients, such as polycaprolactone, aloe vera, vitamin E, mineral oil/baby oil, colorant and possibly other natural ingredients such as apricot or walnut shell powders. PEO/PS based strips may be produced by extrusion. The addition of polycaprolactone may improve the fabrication of the lubricating strip while also easily controlling the strip exposure with small deviations and furthermore may provide smoother strip surfaces as well as enhance the release of PEO during use.

It is contemplated in the present invention that the lubricating materials for the strip or cap may also include polymers such as polyurethane, polyvinylpyrorridone (PVP), nylon, polyethylene, polypropylene, poly(methyl methacrylate), polytetrafluoroethylene, poly(acrylonitrile, butadiene, styrene), and others. Additionally, the lubricating strip could even be comprised of metal, alloys or wood. The lubricating strip could also be rubber, such as silicone and other elastomers. Plastic or rubber strips may be made by extrusion, molding, or calendaring.

It is further contemplated in the present invention that the shaving aid composite may contain more than one lubricating strip; there may be two, three or even more strips, with similar or varying shapes and/or any combination thereof. And as mentioned above, some of these lubricating strips contain a lubricant in the entire strip body while others may have a lubricious layer only on the surface of strip. The top surface of the lubricating strip or cap may or may not be uniform in the present invention.

Thus, one further aspect of this invention is directed towards optimizing the geometries mentioned above (strip exposure and/or strip angle and placement) for different types of lubricating strips for use with a wet shave razor having multiple blades.

As mentioned above, shaving tests have shown that a wide variety of types of strips with a “high strip” or “high cap” (e.g., having a strip exposure as defined above in accordance with the present invention), particularly a positive strip exposure relative to the blades, provide improved shaving benefits, attributes such as better overall performance, comfort during shaving, freedom from nicks, closeness and comfort after shaving, without sacrificing one or the other. One of these advantageous lubricating strips may be an aluminum type strip made by electrical discharge machining. A chromium coating is sputtered on the top surface of an aluminum strip followed by a very thin coating of PTFE applied on the top of chromium. Such a lubricating strip therefore consists of an aluminum base and a chromium interlayer and a polytetrafluoroethylene (PTFE) top layer and is considered a non-leachable lubricating strip. Such a non-leachable strip of the present invention may obtain optimized strip exposure values on average, in the ranges mentioned above of about 0.00 mm to about 0.10 mm, and desirably about 0.00 mm to about 0.05 mm to provide improved shaving attributes.

In accordance with a further aspect of the present invention, the lubricating strip or cap geometry and materials necessarily takes into account the fact that a lubricating strip or the lubricating material on a cap may wear off as the user shaves with the razor cartridge. Thus, it is beneficial to provide a stable geometric relationship between the strip plane and blade plane such that the variation in shaving benefits that one would expect as the strip wears during use is reduced significantly or basically eliminated.

One factor to consider with regard to the strip geometry is that a taller or high lubricating strip may be taller than a shorter lubricating strip not only because it is set higher than the blade plane but because it is perhaps formed with more lubricant on top than a shorter strip. On average though, the taller the strip, the faster the strip wears. Nevertheless, the taller strip will still be more effective at reducing blade force load and possibly load distribution than a shorter strip regardless of its composition, which in turn provides better shaving benefits, such as comfort during and after shaving, etc. without sacrificing any shaving performance.

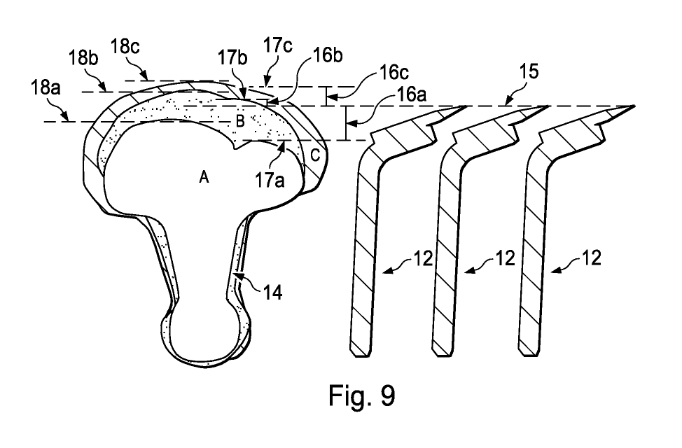

Another factor to consider with regard to the strip geometry and materials is that a lubricating strip typically swells when it comes into contact with fluid such as water (e.g., during shaving). In general, swelling will make the lubricating strip slightly taller. A lubricating strip or cap 14 which when in a dry state may be positioned below the blade plane, but when wet (e.g., during shaving) may rise or swell above the blade plane as shown in FIG. 9. Accordingly, lubricating strip 14 is shown in FIG. 9 before contact with fluid (e.g., dry) as dry strip A having a maximum strip height 18a below the blade plane 15 with a strip exposure 16a of about −0.20 mm to about −0.30 mm.

Lubricating strip 14 is also shown after contact with fluid as swollen strips B and C (e.g., from about 0.5 minutes to 1 minute of contact with fluid for swollen strip B and about 1 to 2 minutes of contact with fluid for swollen strip C) having strip exposures 16b and 16c, ranging from about 0.04 mm to about 0.10 mm, thereby swelling the lubricating strip 14 to heights 18b and 18c above the blade plane height 15.

Swelling, which makes the lubricating strip slightly taller, is beneficial as discussed above, but will also increase the wear rate of the strip since a swollen strip will wear faster than an unswollen strip. To offset the swelling, the addition of an oil (such as mineral oil or baby oil) may play a role in reducing the swelling of the strip so as to provide an appropriate wear rate. The addition of about 1 percent of baby oil in a typical lubricating strip may provide appropriate geometry relative to the blades during the course of shaving history.

Yet another factor to consider related to the strip geometry and materials is that some razor cartridges have mixed blade heights and/or mixed blade types.

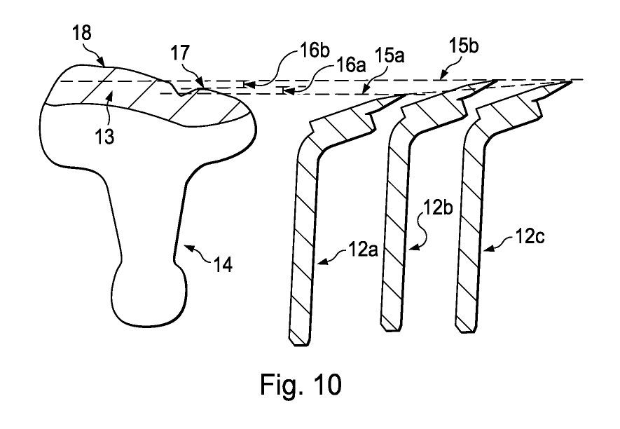

With regard to mixed blade heights, the plurality of blades in the present invention may be arranged with any combination of varying blade plane heights. Referring to FIG. 10, another embodiment of the present invention is shown to include a plurality of blades where the mushroom shaped lubricating strip 14 has a strip exposure 16a greater than the maximum blade plane height 15a of blade 12a which is the rearmost blade or most proximal to the strip 14. In this way, the strip height being at or greater than the height of the most proximal blade or blades protects the user from the sharpness and cutting force of the most proximal blade or blades during shaving.

In FIG. 10, blades 12b and 12c are shown at blade plane height 15b which is greater than blade plane 15a. The lubricating strip 14 has a strip height 17 which is greater than or equal to the blade plane height 15a but lower than blade plane 15b. Accordingly, strip exposure 16b may also be within the desirable range of about −0.10 mm to about 0.00 mm as similarly described above in conjunction with FIG. 2. Generally, as shown, a maximum blade plane height is determined by the highest point of a line drawn between a first blade tip of the blade most proximal to the lubricating body 14 (blade 12a) and a second blade tip of the blade least proximal to the lubricating body 14 (blade 12c).

The razor system of the present invention may have a strip arranged relative to a razor cartridge where all the blades are of the same type, e.g., all are sharper and slimmer than a traditional razor blade, or of mixed types, sharpness, slimness, strength, etc. Sharp, slim blades are described in U.S. Pat. Nos. 6,866,894 and 6,684,513 and co-pending U.S. patent application Ser. No. 12/174,093, filed simultaneously on Jul. 16, 2008 entitled Razors and Razor Cartridges, commonly assigned. A typical thickness of a stainless steel blade substrate may be about 75 μm. A cutting edge formed with a wedge-shaped configuration may have an ultimate tip radius of about 200 to about 300 angstroms, where the cutting edge may be coated with a diamond-like carbon hard layer, a chromium overcoat layer and a very thin polytetrafluoroethylene (PTFE) outer layer.

Thus, in yet another embodiment of the present invention (not shown) the strip may be combined with some blades that are sharp and slim but others that are normal or traditional, e.g. four sharp blades and one normal blade. Tests have substantially determined that higher strip exposures with the sharper/slimmer blades provided the best shaving attributes, comfort and closeness. Accordingly, even though the sharper/slimmer blades provide closeness attributes, the discomfort, irritation, and other negative effects associated with having a majority of sharper/slimmer blades in a cartridge may be minimized or diminished significantly through the geometry of the lubricating strip or cap while also still providing the closeness shaving attribute and without sacrificing other shaving attributes. Formulation and fabrication processes (e.g., extrusion or molding) may also play a role because they may indirectly affect the strip geometry by varying the wearing and swelling rates when the strip gets wet during shaving.

It should also be noted therefore, that while improved results in comfort and closeness are seen with a higher strip and the sharper/slimmer blades, effectively, regardless of the type, height, or combination thereof of the blades in the cartridge, the fact that there is a strip exposure within the ranges described above, improved shaving attributes are provided. This follows for the strip angle as well.

Such shaving improvements related to lubricating strip exposure have been verified in both manual and power wet shave razor systems having multiple blades.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising:
a plurality of blades and at least one lubricating body in a dry state, said body having a maximum height greater than or equal to a maximum blade plane height of said plurality of blades and wherein one of said plurality of blades is most proximal to said at least one lubricating body, said most proximal blade being a low cutting force blade.

2. The razor cartridge of claim 1 wherein the lubricating body is a lubricating strip, a cap, a coated cap or any combination thereof.

3. The razor cartridge of claim 1 wherein said at least one lubricating body comprises a mushroom shape, a round shape, a semi-round shape, a triangular shape, a rectangular shape, a square shape, a sloped shape, or any combination thereof.

4. The razor cartridge of claim 1 wherein said plurality of blades are comprised of low cutting force blades, slim blades, strong blades, or any combination thereof.

5. The razor cartridge of claim 1 wherein said plurality of blades are at the same height relative to each other.

6. The razor cartridge of claim 1 wherein said plurality of blades are at different heights relative to each other.

7. The razor cartridge of claim 1 wherein said lubricating body is in contact with fluid.

8. The razor cartridge of claim 1 wherein said maximum blade plane height is determined by a highest point of a line drawn between a first blade tip of said blade most proximal to said at least one lubricating body and a second blade tip of said blade least proximal to said at least one lubricating body.

9. The razor cartridge of claim 1 wherein said maximum lubricating body height is determined as an uppermost skin contacting surface of the lubricating body.

10. A razor cartridge comprising:
a plurality of blades and at least one lubricating body in a dry state having a strip exposure greater than zero millimeters and wherein one of said plurality of blades is most proximal to said at least one lubricating body, said most proximal blade being a low cutting force blade.

11. The razor cartridge of claim 10 further comprising a strip angle greater than zero degrees.

12. The razor cartridge of claim 10 wherein said strip exposure is between greater than 0.00 mm and about 0.10 mm.

13. The razor cartridge of claim 11 wherein said strip angle is between greater than zero degrees and about 10 degrees.

14. The razor cartridge of claim 10 wherein said lubricating body is a strip, cap, coated cap or any combination thereof.

15. The razor cartridge of claim 10 wherein said lubricating body comprises a mushroom shape, a round shape, a semi-round shape, a triangular shape, a rectangular shape, a square shape, a sloped shape, or any combination thereof.

16. The razor cartridge of claim 10 wherein said plurality of blades are comprised of low cutting force blades, slim blades, strong blades, or any combination thereof.

17. The razor cartridge of claim 10 wherein said plurality of blades are at the same height relative to each other.

18. The razor cartridge of claim 10 wherein said plurality of blades are at different heights relative to each other.

19. The razor cartridge of claim 10 wherein said strip exposure is relative to a blade or blades of said plurality of blades most proximal to said lubricating body.

20. A razor cartridge comprising:
a plurality of blades and at least one lubricating body in a dry state having a strip exposure greater than zero millimeters and a strip angle greater than zero degrees and wherein one of said plurality of blades is most proximal to said at least one lubricating body, said most proximal blade being a low cutting force blade.
